(19) United States
(12) Patent Application Publication
(10) Pub. No.: US 2005/0001972 A1
(43) Pub. Date: Jan. 6, 2005

(54) Bistable liquid crystal device having two drive modes

(76) Inventors: Sander Jurgen Roosendaal, Eindhoven (NL); Mark Thomas Johnson, Eindhoven (NL); Dirk Kornelis Gerhardus De Boer, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/496,347

(22) PCT Filed: Oct. 25, 2002
(86) PCT No.: PCT/IB02/04479

(30) Foreign Application Priority Data
Nov. 22, 2001 (EP) 01309813.2

(51) Int. Cl. C09K 19/02; G02F 1/1343

(52) U.S. Cl. 349/179; 349/141

(57) ABSTRACT

A twisted nematic bistable liquid crystal (2) switching between two stable states in a high voltage mode is used in an AMLCD low voltage drive. The picture electrodes (14) and the counter electrode (15) are part of an active matrix, enabling the display to be used also in a fast video mode. Thus, a bistable liquid crystal display device is provided which has two drive modes, a low frequency mode, (first drive mode, also called “bistable mode”, “passive mode” or “high voltage mode”) for applications requiring slower switching times and lower power consumption and a high frequency mode (second drive mode, also called “active mode, “active matrix drive mode” or “fast video mode”) for grey scale images and video applications.

The invention relates to a liquid crystal display device comprising a nematic liquid crystal material between a first substrate and a second substrate, at least one substrate being provided with electrodes, which define picture elements, the device comprising driving means for driving the picture elements in a first mode of driving between two stable states.

Liquid crystal display effects, based on bistability of a nematic liquid crystal material, are well known. One example is the supertwist nematic effect, showing two stable states, which is used in many display applications, ranging from mobile phones to laptop computers. Other bistable electro-optical effects have been described, for instance, by Dozov et al. (“Recent Improvements of Bistable nematic Displays Switched by Anchoring Breaking”, SID 2001, pages 224-7) and by Guo et al.(Three-terminal bistable twisted nematic liquid crystal displays”, Applied Physics Letters, Vol. 77, No 23, pages 3716-3718).

Bistable liquid crystal displays have a very low power consumption if the update frequencies are low. This makes them very suitable for applications in mobile devices like electronic books. However, in these applications a growing need exists for the possibility to show images having color, grey-scales and video content.

In general, it is not very well possible to fulfill these needs with the bistable electro-optical effects. In general, they are restricted to only a few color applications and switching times (of the order of 300 ms) which are too slow for video applications (which require switching times of the order of 10-20 ms).

It is one of the objects of the invention to overcome these drawbacks by providing a bistable liquid crystal display device having two drive modes, of driving viz. a low frequency mode for applications requiring slower switching times and a high frequency mode for e. g. video applications.

It is another object of the invention further has as one of its objects to provide a bistable liquid crystal display device which is also suitable for video applications or other applications which require a high frequency mode.

To this end, a liquid crystal display device according to the invention comprises driving means for driving the picture elements in a first mode of driving between two stable states, liquid crystal molecules in the stable states having different twist angles, viewed from one substrate to another in said first drive mode and driving means for driving the picture elements in a second mode of driving between two optical extremes of the picture elements, the difference in twist angles of the liquid crystal molecules, viewed from one substrate to another in said second drive mode, being substantially constant.

An optimal extreme in this connection may refer to an extreme in a voltage vs. light transmission curve, a voltage vs. light reflection curve or a voltage vs. light adsorption curve.

The invention is based on the insight that, by preventing the molecules from twisting too much in the second drive mode, the molecules switch faster between intermediate states, which states may be determined by a voltage provided by a switching device. Too much twisting can be prevented in the second mode by limiting the voltages on the picture elements to a maximum value at which substantially switching to the other bistable states is initiated. In this second mode, the difference in twist angles of the liquid crystal molecules, viewed from one substrate to another in said second mode, may be different from the difference in twist angles in one of the stable states due to surface effects or due to the kind of driving (e.g. due to lateral switching fields)

In the first drive mode, generally higher switching voltages are needed. If active matrix driving is used (e.g. a TFT—matrix) in the second mode, the active matrix will generally not be capable of providing the high voltages required for the first drive mode, and in addition, it will be necessary to modulate said first drive mode for time periods which may not correspond to complete frame periods. In many cases, shorter pulses will be required to set up bistable states in said first drive mode. In one possible solution, the display is provided with two complete drive systems, an active matrix and a passive (if necessary with reset) drive system, for example by providing strip-shaped electrodes on the second substrate, which could be driven from a separate passive matrix type driving chip. In the active matrix mode, the electrodes on the second substrate would be shorted (virtually) and driven with the adequate signals. In addition, the columns could also be attached to a second (higher voltage) chip if the normal column driver delivers insufficient voltage for passive (reset) driving.

In a first embodiment the liquid crystal display device has comb-shaped electrodes for each picture element and a further electrode on the first substrate.

The driving means for driving the picture elements in the first drive mode in this embodiment provide driving pulses to the comb-shaped electrodes on the first substrate and driving pulses to the further electrode.

If the second substrate is provided with strip-shaped electrodes, the liquid crystal display device now has driving means for driving the picture elements in the first drive mode and provide driving pulses to the comb-shaped electrodes on the first substrate and driving pulses to the further strip-shaped electrode.

In the first drive mode, generally higher voltages are required than in the active matrix mode. To prevent using a high voltage driver, driving means comprising means for bringing the picture element to a defined state may be introduced, so a commercially available (low voltage) driver device can be used.

To this end, one embodiment of the liquid crystal display device comprises two row electrodes for each row of picture electrodes and column electrodes on the first substrate, the switching element comprising at least two thin-film transistors, each thin-film transistor being selectable by one of said two row electrodes.

In another embodiment, a pulse for bringing the picture element to the defined state is produced by capacitive coupling.

The driving speed in the second (active matrix) is increased if the picture element at the first substrate comprises at least three electrodes, the driving means comprising means for generating electric fields in different (preferably substantially perpendicular) directions.

If necessary, the second (active matrix) drive mode can be supplied to a bistable liquid crystal display device without coupling it to a first (passive) mode. The device then comprises driving means for driving the picture elements in a mode of driving between two optical extremes of the picture elements, the difference in twist angles of the liquid crystal molecules, viewed from one substrate to another in said drive mode, being substantially constant These and other aspects of the invention are apparent from and will be elucidated with reference to the embodiments described hereinafter.

In the drawings:

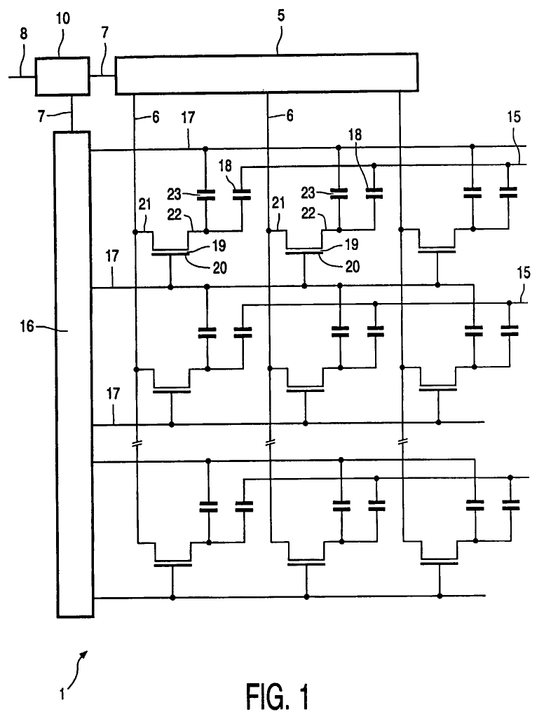

FIG. 1 is an electric circuit diagram of the display device,

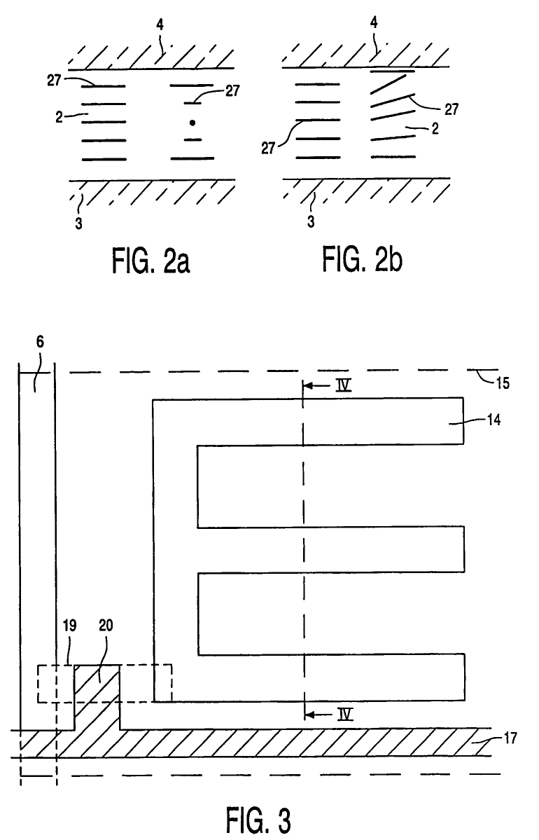

FIG. 2 is a cross-section of a display cell of a device according to the invention,

FIG. 3 is a plan view of a picture electrode in a display cell of a device according to the invention,

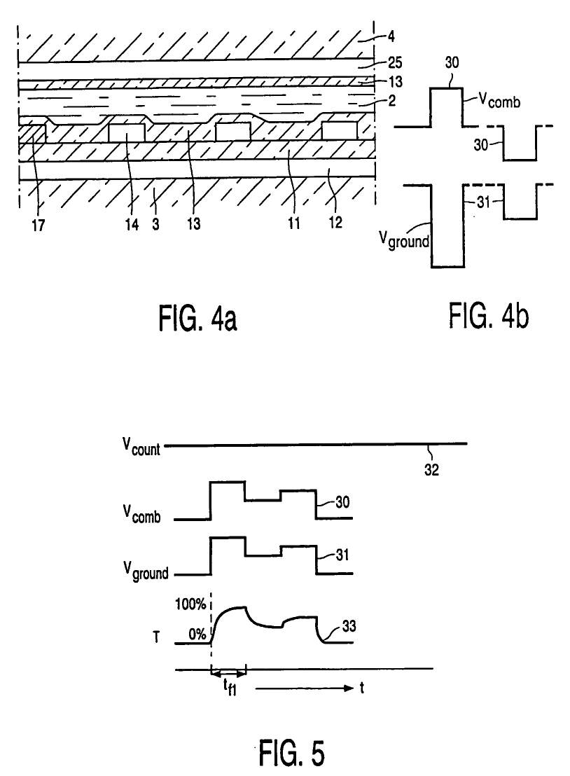

FIG. 4 is a cross-section taken on the line IV-IV in FIG. 2,

FIG. 5 shows the response of such a display device,

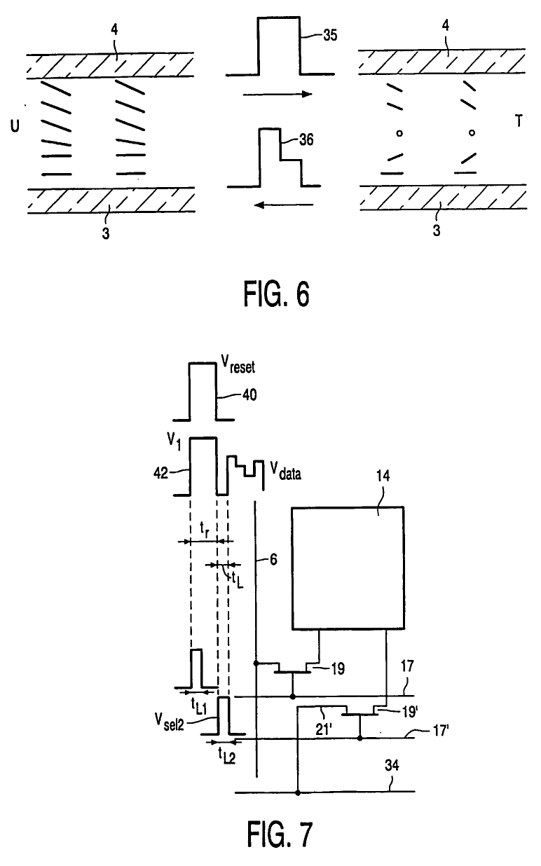

FIG. 6 shows another effect to which the invention is applicable,

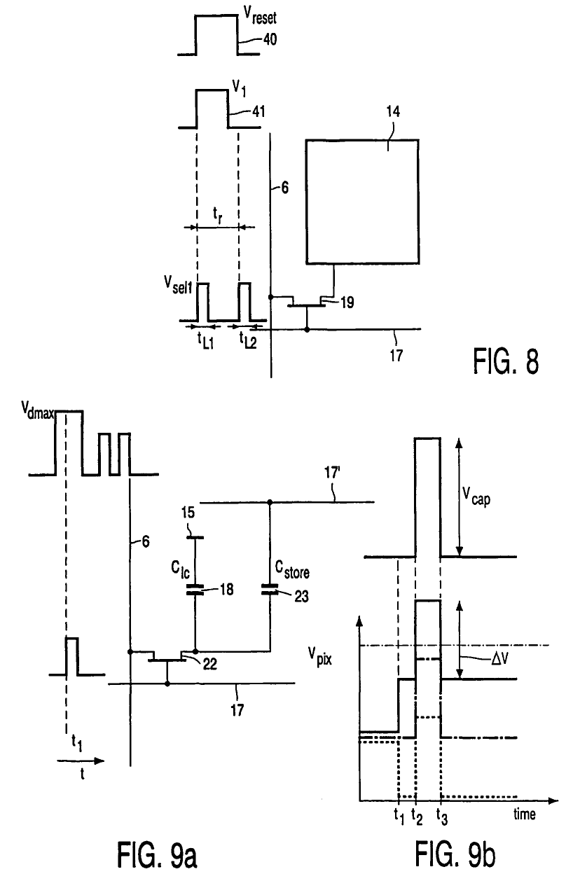

FIGS. 7, 8 are plan views of other picture electrodes in a display cell of devices according to the invention,

FIG. 9 is a plan view of a picture electrode in a display cell of another device according to the invention, together with a driving pulse,

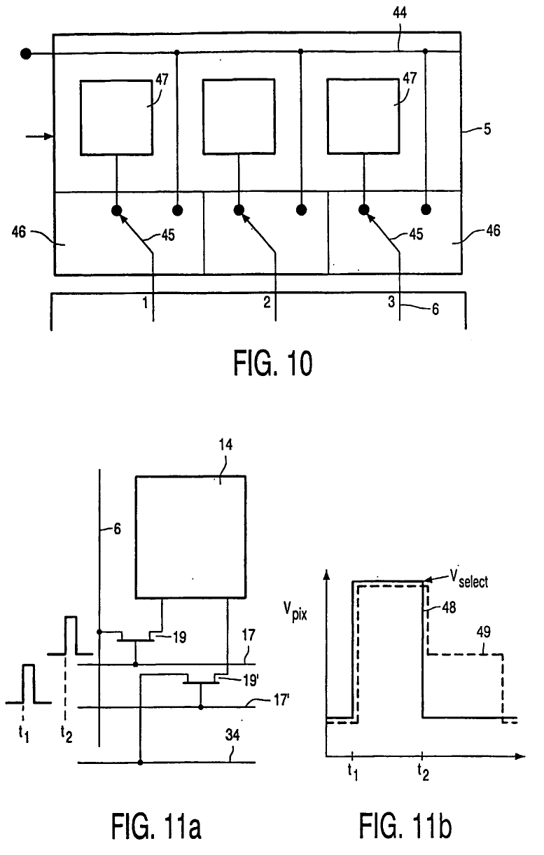

FIG. 10 shows part of a device for generating the column pulses, while

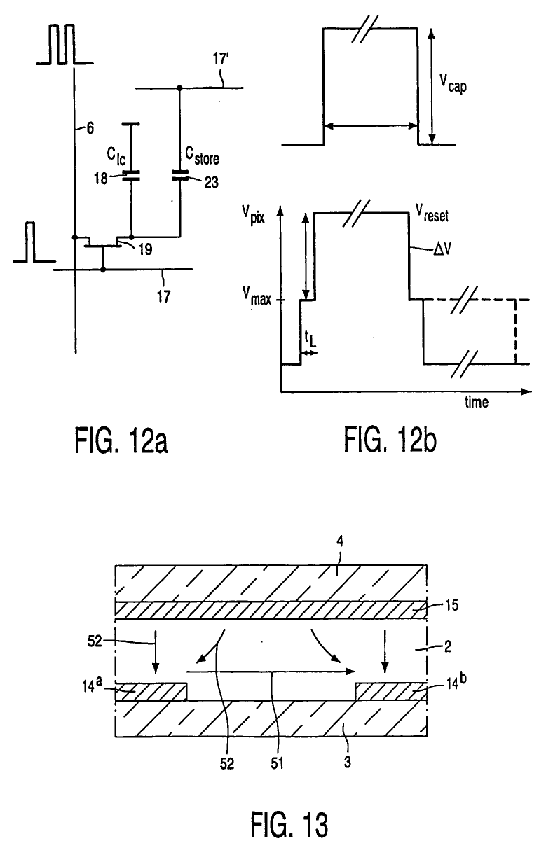

FIGS. 11, 12 are plan views of picture electrodes in display cells of other devices according to the invention, together with the driving pulses, and

FIG. 13 is a cross-section of another display cell.

The Figures are diagrammatic and not drawn to scale; corresponding parts are generally denoted by the same reference numerals.

FIG. 1 is an electric equivalent circuit diagram of a part of a display device 1 to which the invention is applicable. It comprises a matrix of pixels 18 at the area of crossings of row or selection electrodes 17 and column or data electrodes 6. The row electrodes are consecutively selected by means of a row driver 16, while the column electrodes are provided with data via a data register 5. To this end, incoming data 8 are first processed, if necessary, in a processor 10. Mutual synchronization between the row driver 16 and the data register 5 takes place via drive lines 7.

In one drive mode, called the “active mode” signals coming from the row driver 16 select the picture electrodes via thin-film transistors (TFTs) 19 whose gate electrodes 20 are electrically connected to the row electrodes 17 and the source electrodes 21 are electrically connected to the column electrodes. The signal which is present at the column electrode 6 is transferred via the TFT to a picture electrode of a pixel 18 coupled to the drain electrode 22. The other picture electrodes are connected to, for example, one (or more) common counter electrode(s) 15.

FIG. 2 is a cross-section of a part of a liquid crystal material 2 which is present between two substrates 3, 4 of, for example, glass or (flexible) synthetic material, provided with (ITO or metal) picture electrodes (not shown) and a counter electrode (not shown), respectively. As described by Guo et al. (Three-terminal bistable twisted nematic liquid crystal displays”, Applied Physics Letters, Vol. 77, No 23, pages 3716-3718), if bistable liquid crystal displays are used, switching occurs between two bistable states φ, φ+π (schematically shown in FIG. 2a, in which the (directors 27 of the) liquid crystal molecules either have a twist (right side) or no twist (left side)).

Switching between the two bistable states is obtained by pulses of rather high voltages (of the order of 15-30 V), the threshold voltage for switching being rather high. However, the inventors have found that, by using voltages below said threshold voltage, a drive mode of fast switching between grey-levels in a grey-scale between two transmission extremes is possible. One of the two states may be a first state in which substantially all (directors 27 of the) liquid crystal molecules have an orientation parallel to the first substrate 3, schematically shown in FIG. 2b, (left side). This state is comparable to one of the two bistable states. In the other transmission extreme, tilting of the (directors 27 of the) liquid crystal molecules occurs, introducing polarization change. Between crossed polarisers, in this example, a dark pixel is obtained (left side, no voltage) or a white or gray pixel is obtained (right side), dependent on the voltage used. Since substantially no twisting occurs, said driving between two transmission extremes can be much faster than the driving between the bistable states.

The (directors 27 of the) liquid crystal molecules do not necessarily have to tilt. Also a twisting effect, comparable to the “in plane switching” effect is possible. A picture element using this effect is shown in FIGS. 3, 4. FIG. 3 is a plan view and FIG. 4 is a cross-section taken on the line IV-IV in FIG. 3 of a part of a liquid crystal device. Liquid crystal material 2 is present between two substrates 3, 4 of, for example, glass or (flexible) synthetic material, provided with (ITO or metal) comb-shaped picture electrodes 14 and a counter electrode 15, respectively. The combshape of the picture electrodes 14 introduces fringe fields, needed for the switching between the bistable states. The device also comprises orientation layers 13, which orient the liquid crystal material on the inner walls of the substrates. Moreover, the device comprises a polarizer (not shown) and a (mutually perpendicularly crossed) analyzer. In this case, the liquid crystal material is a (twisted) nematic material having a positive dielectric anisotropy. The device further comprises (ITO) ground plane electrodes 12, isolated from the picture electrodes 14 by an isolation layer 11.

In a first drive mode, the “bistable mode” or “passive mode”, signals V_{comb} (voltages indicated by pattern 30 in FIG. 4b) on comb-shaped picture electrodes 14 and V_{ground} (voltages indicated by pattern 31 in FIG. 4b) on ground plane electrodes 12, are used to switch from a dark state to a light state and to switch from a light state to a dark state, respectively.

FIG. 3 shows row or selection electrodes 17 and column or data electrodes 6. As described above, in the second drive mode, called the “active mode”, the picture electrodes are selected via (schematically shown) thin-film transistors (TFTs) 19 whose gate electrodes 20 are electrically connected to the row electrodes 17, while the source electrodes 21 are electrically connected to the column electrodes. The signal that is present at the column electrode 6 is transferred via the TFT to the picture electrode 14. Dependent on the voltages used, some twisting and tilting is induced in the liquid crystal molecules, defining a certain grey value. The signal on the picture element, however, should not be so high that switching to the other bistable state may occur.

FIG. 5 shows one way of switching in the fast “active mode”. First (a part of) the display is reset by a sufficiently high voltage (e.g. 40 V), between counter electrode 15 and the electrodes 12, 14, comparable to FIG. 4(the pulse for resetting may be much shorter than a frame period). Subsequently, during a first frame period t_{fl} the voltage V_{count} is held at e.g. 0V (voltage pattern 32) while both the picture electrode 14 and ground plane electrode 12 are given a high voltage (V_{comb}, V_{ground}, voltage patterns 30, 31). If necessary, the picture electrode 14 and ground plane electrode 12 may be given the same voltage e.g. by introducing an extra witch. During line selections in the subsequent frame periods, (lower) voltages between the counter electrode 15 and the electrodes 12, 14 define grey values. The resulting transmission curve is indicated by reference numeral 33.

Said reset voltage as well as the “bistable mode” or “passive mode” signals in the first drive mode, as shown in FIG. 4b are applied via said thin-film transistors (TFTs) 19.

Similar remarks apply to a device, based on the effect described in Dozov et al. (“Recent Improvements of Bistable Nematic Displays Switched by Anchoring Breaking”, SID 2001, pages 224-7). FIG. 6 schematically shows again two bistable states φ, φ+π, in which the (directors 27 of the) liquid crystal molecules either have a twist (right side, T state) or no twist (left side, U state). A pulse pattern 35 introduces switching from the U state to the T state, whereas a (voltage) pulse pattern 36 introduces switching from the T state to the U state. Using this effect in a passive matrix, multiplex driving is possible with line voltages of up to 16 V and column voltages of ±2 V.

The display device of FIG. 1 also comprises an auxiliary capacitor 23 at the location of each pixel. The auxiliary capacitor may be connected between the common point of the drain electrode 22 and the pixel in a given row of pixels at one end, and the row electrode of the previous row of pixels at the other end; other configurations are alternatively possible, for example, between said common point and the next row of pixels, or, as shown in FIG. 1, between this point and an extra row electrode 17 for a fixed (or variable) voltage.

In this embodiment, the display device comprises separate electrodes 15, but these electrodes may also be provided as a single common electrode (counter electrode). As will be discussed later, these extra capacitances may be involved in generating the high voltage pulses, as needed for either resetting (part of) the display or generating the high voltage pulses for bistable addressing (first mode).

In FIG. 7, the matrix column driver 5 is provided with drivers providing a sufficiently high voltage Vᵣₑₛₑₜ (pulse 40) for the reset and bistable addressing (first mode). The necessary duration of the voltage pulse is obtained by selecting a voltage Vₜ (pulse 42) during a first line time t₁₁ via TFT transistor 19, selected via row electrode 17 and driving the voltage back to zero after a defined time period tᵣ via a second TFT transistor 19′, selected via an extra row electrode 17′ during a second line time t₁₂. Drain 21′ of transistor 19′ is coupled (capacitively or direct) to a voltage line 34, in this example ground. It is alternatively possible to select TFT 19 again after a defined time period tᵣ to reset every pixel to a reference voltage (e.g. zero) (FIG. 8). The reset pulse can scan from top to bottom across the display (row at a time) or be applied to the complete display.

FIG. 9 shows an embodiment in which low voltage column drivers 5 do not produce a sufficiently high voltage to enable the reset driving as described above. Part of a display, similar to the display of FIG. 1 is schematically shown, the pixel 18 being indicated by its capacitance C_{1c}. The storage capacitor 23, indicated by its capacitance Cₛₜₒᵣₑ, parallel to the pixel is used to couple (additional) voltage to the pixel. In this embodiment, a separate selection line 17′ is used for coupling the voltage to the pixel. First, the pixel is driven at time t₁ with the maximum voltage V_{cmax}, available from the column driver, after which the additional voltage is added by capacitive coupling at time t₂ (full line in FIG. 9b). The magnitude of the additional voltage is determined by the applied voltage V_{cap} on selection line 17′ and the ratio of the pixel to storage capacitors (a large storage capacitance is preferred), whilst the timing interval t₂−t₃ is determined by the pulse on the storage capacitance line. This additional voltage is determined by ΔV=V_{cap}.(Cₛₜₒᵣₑ/C_{1c}+Cₛₜₒᵣₑ)). Pixels which do not require the high select voltage are selectable by first driving these pixels to either the lowest possible column driver voltage (i.e. 0V in this example—see dash-dot line in FIG. 9b) or even to a maximum voltage of opposite polarity (dotted line in FIG. 9b) just before applying the capacitive coupling. In this way, they will not reach the voltage required to switch, and will remain in the initially defined state. The storage capacitor may also be connected to the next or previous row 17 as shown in FIG. 1.

In the embodiment of FIG. 10, column lines 6 can be directly connected to a high voltage line 44. In this embodiment, the high voltage is made available in the column driver IC as a single high voltage (power) line 44. A switch 45 in each (IC) output buffer 46 is used to connect the column lines 6 to either the high voltage line 44 or to the normal low voltage (grey scale) output driving circuit 47. To change the bistable state, the pixels are driven to the high voltage and held for a longer period (e.g. a full fame period, or integral thereof). The selection switch is connected to the high voltage line (see column 2 in FIG. 10). Pixels which do not require their state to change will be connected directly to the low voltage output driving circuit 47 (columns 1 and 3 in FIG. 10).

When driving the display in the bistable mode, the high voltage line must be activated. To reduce power dissipation, it is advisable to disable the high voltage line (cut off the high voltage power supply) whilst the display is operating in the normal active matrix mode. Preferably the power supply voltage is thus changed, depending upon the display mode used.

An embodiment to obtain the pulses as shown in FIG. 6 (for a device as described by Dozov et al. (“Recent Improvements of Bistable Nematic Displays Switched by Anchoring Breaking”, SID 2001, pages 224-7) is shown in FIG. 11. Selection is carried out by applying a high voltage (e.g. 15V), and either returning to 0V in a single step to the twisted state (pulse 48 in FIG. 11b) or with a pause at an intermediate voltage (to the non-twisted state pulse 49 in FIG. 11b).

In this embodiment, using low voltage column drivers, the pixels are connected (via a TFT 19′) to a high voltage select line 17′, made available from the row driver 16. In this direct drive embodiment, it would be possible to address all pixels in a row to high voltage (from V_{select}) during a first frame at t₁, and then carry out a selection to either 0 V (pulse 48 in FIG. 11b), or to an intermediate voltage (e.g. 5 V) during a second frame at t₂ ( pulse 49 in FIG. 11b), before returning all pixels to ₀V in a third frame. These devices may also be driven faster. The first part of the signal (above threshold, as indicated by t₁−t₂) could be, for example, at least 50 μs, while the second part of the signal may have any duration between 50 μs and a frame time. Next to selecting the entire display before the second gate pulse is applied, it is possible to make a line after line selection to bring separate lines successively to a defined state.

FIG. 12 shows an embodiment in which (an entire row of) pixels are driven to the high voltage using a capacitive coupling from a separate capacitor line, in a similar way as described with respect to FIG. 9. Again all pixels are addressed to the maximum pixel voltage Vₘₐₓ and then to V_{select}. This select voltage is again obtained by adding the capacitive voltage ΔV (e.g. one line time after driving the pixel to pixel voltage Vₘₐₓ). In this case, the voltage is held high until just before the following address period (in the following frame) when the capacitive coupling returns to zero. At the next address period, pixels which are to be twisted are addressed to 0V (fixed line in FIG. 12b, comparable to line 48 in FIG. 11b) directly after the capacitive voltage step (within a few microseconds). This will appear to the LC as if it is directly returned to 0V, and the twisted state will be created. Pixels, which should not be twisted, should be addressed to an intermediate pixel voltage (e.g. pixel voltage Vₘₐₓ) and held at said voltage for a sufficiently long period before being returned to 0V in a later frame (dashed line in FIG. 12b, comparable to line 49 in FIG. 11b).

The driving speed, especially in the “active” mode, when the molecules tilt between different positions, according to the grey value, is enhanced by “dynamic driving”. One example is shown in FIG. 13 in which the picture electrode 14 has been split up into sub-electrodes 14^{a}, 14^{b} which are driven by separate column lines and TFTs (not shown). Dependent on the voltages on the datalines and on the counterelectrode 15, electric fields are introduced between these electrodes. Electrodes 14 are suited for generating electric fields 51 parallel to the substrates 3, 4, whereas these electrodes together with counterelectrode 15 are suited for generating electric fields 52 normal to the substrates 3, 4. By suitable choices of voltages during switching, the torque which the resulting electric field exercises on the (directors of the) liquid crystal molecules is optimized both during switching on and during switching off in the “active” mode.

The protective scope of the invention is not limited to the embodiments described. For instance, the pulse shape 36 as described in FIG. 6 may be different (linearly or exponentially decreasing in the second part), for instance, by means of a (controlled) resistor to a (fixed) voltage, if necessary, controlled by an extra switch. The invention resides in each and every novel characteristic feature and each and every combination of characteristic features. Reference numerals in the claims do not limit their protective scope. Use of the verb “comprise” and its conjugations does not exclude the presence of elements other than those stated in the claims. Use of the article “a” or “an” preceding an element does not exclude the presence of a plurality of such elements.

1. A liquid crystal display device comprising a nematic liquid crystal material between a first substrate and a second substrate, at least one substrate being provided with electrodes, which define picture elements, the device comprising driving means for driving the picture elements in a first mode of driving between two stable states, liquid crystal molecules in the stable states having different twist angles, viewed from one substrate to another in said first drive mode, and driving means for driving the picture elements in a second mode of driving between two optical extremes of the picture elements, the difference in twist angles of the liquid crystal molecules, viewed from one substrate to another in said second drive mode, being substantially constant.

2. A liquid crystal display device as claimed in claim 1, wherein the difference in twist angles of the liquid crystal molecules, viewed from one substrate to another in said second mode, is different from the difference in twist angles in said first drive mode.

3. A liquid crystal display device as claimed in claim 1, wherein in the second mode the voltages on the picture elements have a maximum value at which no switching to the first mode occurs.

4. A liquid crystal display device as claimed in claim 1, comprising, on the first substrate, a switching element between a driving electrode and a picture electrode.

5. A liquid crystal display device as claimed in claim 4, comprising row electrodes and column electrodes on the first substrate, the switching element being a thin-film transistor.

6. A liquid crystal display device as claimed in claim 4, comprising strip-shaped electrodes on the second substrate.

7. A liquid crystal display device as claimed in claim 1, having for each picture element comb-shaped electrodes and a further electrode on the first substrate.

8. A liquid crystal display device as claimed in claim 6, comprising strip-shaped electrodes on the second substrate, the driving means for driving the picture elements in a first drive mode providing driving pulses to the comb-shaped electrodes on the first substrate and driving pulses to the strip-shaped electrodes on the second substrate.

9. A liquid crystal display device as claimed in claim 7, wherein the driving means for driving the picture elements in a first drive mode provide driving pulses to the comb-shaped electrodes on the first substrate and driving pulses to the further electrode.

10. A liquid crystal display device as claimed in claim 1, wherein the picture element at the first substrate comprise at least two electrodes, the driving means comprising means for generating electric fields in two different directions.

11. A liquid crystal display device as claimed in claim 10, wherein in which the electric fields have substantially perpendicular directions.

12. A liquid crystal display device as claimed in claim 1, wherein the driving means for driving in the first mode comprise means for bringing the picture element to a defined state.

13. A liquid crystal display device as claimed in claim 12, comprising row electrodes and column electrodes on the first substrate, the switching element comprising a thin-film transistor, the driving means comprising means for producing a pulse for bringing the picture element to the defined state.

14. A liquid crystal display device as claimed in claim 12, comprising two row electrodes for each row of picture electrodes and column electrodes on the first substrate, the switching element comprising at least two thin-film transistors, each thin-film transistor being selectable by one of said two row electrodes.

15. A liquid crystal display device as claimed in claim 12, wherein a pulse for bringing the picture element to the defined state is produced by capacitive coupling.

16. A liquid crystal display device as claimed in claim 1, wherein the difference in twist angles, viewed from one substrate to another in said first drive mode, is substantially 180 degrees or a multiple of 180 degrees.

17. A liquid crystal display device comprising a nematic liquid crystal material between a first substrate and a second substrate, at least one substrate being provided with electrodes, which define picture elements, the liquid crystal molecules being able to obtain two stable states having different twist angles, viewed from one substrate to another, the device comprising driving means for driving the picture elements in a mode of driving between two optical extremes of the picture elements, the difference in twist angles of the liquid crystal molecules, viewed from one substrate to another in said drive mode, being substantially constant.

18. A liquid crystal display device as claimed in claim 11, wherein the voltages on the picture elements have a maximum value at which no switching to another stable state occurs.
